(19) United States
(12) Patent Application Publication
(10) Pub. No.: US 2006/0118416 A1
(43) Pub. Date: Jun. 8, 2006

(54) Electrochemical sensor system

(75) Inventors: James Z. Liu, Rockford, IL (US); Robert A. Nickels, Freeport, IL (US)

Correspondence Address: Kris T. Fredrick;Honeywell International, Inc., 101 Columbia Rd., P.O. Box 2245, Morristown, NJ, 07962, US

(73) Assignee: Honeywell International, Inc.

(21) Appl. No.: 11/010,221

(22) Filed: Dec. 8, 2004

(51) Int. Cl. G01N 27/26

(52) U.S. Cl. 204/431; 204/400

(57) ABSTRACT

An electrochemical sensor system includes a filter comprising a micro-porous solid possessing a large surface area, wherein the solid porous material may contain alkaline materials and the filter is located within a container sealed with a cap, and includes a water reservoir containing water or a water-based solution and a heater disposed proximate to the water reservoir. The heater can be utilized to heat the water reservoir. This sensor system further comprises a heater and hydrogen generating chamber disposed proximate to the charcoal filter within the container. Additionally, a layer comprising water trapped within a polymer matrix can be provided wherein the layer is located below the heater and hydrogen generating chamber within the container in order to slow down water evaporation and provided extended electrochemical sensing capabilities for the electrochemical sensor system.

### TECHNICAL FIELD

Embodiments are generally related to sensing. Embodiments are also related to hydrogen detection. Embodiments are additionally related to sensory arrays for hydrogen detection. Embodiments are further related to electrochemical hydrogen sensors.

### BACKGROUND OF THE INVENTION

Electrochemical hydrogen (H₂) sensors are utilized in a number of sensing applications, including fuel cells, transformer monitoring systems, in the monitoring of chemical, petroleum, plastic, space and glass industries. An H₂ sensor can be of tremendous value in such applications, not only from a safety standpoint, but are also economically beneficial.

The earliest H₂ sensors were based on palladium (Pd). Hydrogen absorbs on Pd surfaces and diffuses into its bulk, altering its electrical properties. This type of sensor, however, undergoes phase change at high H₂ concentrations. Such a scenario could result in an expansion of the Pd lattice. This problem was overcome by alloying palladium with nickel. Using Pd-Ni alloy, sensors can detect hydrogen from ppm to 100% concentrations.

Such sensors, however, are affected by gases like carbon monoxide (CO), sulfur dioxide (SO₂), hydrogen sulfide (H₂S), VOCs, oil vapor and the so forth. In applications such as those involving high humidity with and the presence of SO₂, H₂S and NO₂, for example, Pd—Ni can become poisoned or corroded. Further, VOC and oil vapor can cause problems for Pd H₂ sensors.

Electrochemical sensors could be utilized in H₂ detection and possess many advantages over conventional tin oxide based or Pd based sensors. The freezing/boiling of the water reservoir, however, limits the working temperature range of electrochemical sensors. As the temperature of the cell decreases, the chemical reaction, which the user “sees” as a signal decreases. At some point, depending upon the electrolyte, the cell current stops. Usually, upon returning to a normal temperature, the cell reactivates.

If an electrochemical sensor is to be utilized in temperatures below its normal operating temperature range, the cell should be heated. In general, the lowest temperature at which a cell can be expected to function properly over long periods of time is 0C. Additionally, there is cross-sensitivity among H₂, CO, CH4, and C₂H₂, etc., which can cause false alarms.

The embodiments disclosed herein therefore address the aforementioned problems associated with conventional electrochemical sensing systems.

### BRIEF SUMMARY

The following summary is provided to facilitate an understanding of some of the innovative features unique to the present invention and is not intended to be a full description. A full appreciation of the various aspects of the embodiments can be gained by taking the entire specification, claims, drawings, and abstract as a whole.

It is, therefore, one aspect of the present invention to provide for an improved sensor system.

It is another aspect of the present invention to provide for an improved electrochemical sensor system.

It is yet another aspect of the present invention to provide for a hydrogen sensor system.

The aforementioned aspects of the invention and other objectives and advantages can now be achieved as described herein. In accordance with one embodiment, an electrochemical sensor system can be provided, which includes a filter comprising a micro-porous solid possessing a large surface area, wherein the filter is located within a container sealed with a cap. Such a system further can include a heater and hydrogen generating chamber disposed proximate to the charcoal filter within the container. Additionally, a layer comprising water trapped within a polymer matrix can be provided wherein the layer is located below the heater and hydrogen generating chamber within the container in order to slow down water evaporation and provided extended electrochemical sensing capabilities for the electrochemical sensor system. The water trapped within the polymer matrix generally can comprise a water-gel. Additionally, one or more hydrophobic layers can be disposed between the filter and the water-gel, which can include or be associated with an antiseptic solution.

Additionally, a gas diffusion control layer can be disposed between the heater and hydrogen generating chamber and the hydrophobic layers, wherein a plurality of holes are formed from the gas diffusion control layer, which link the heater and hydrogen generating chamber to one or more of the hydrophobic layers. Additionally, one or more electrolytes and catalyst electrodes can be disposed between a first hydrophobic layer and a second hydrophobic layer. The container can be configured from nickel-plated steel. The cap can also be formed from nickel-plated steel. The micro-porous solid can posses a large surface area in a range of approximately 200 m²/g to 1000 m₂/g. In applications like high humidity with presence of SO2, H2S and NO2, the hydrogen sensitive electrodes, i.e., Pd or Pd—Ni will get poisoned or corroded. Alkaline porous materials are added to the micro-porous solid to get rid of those corrosive gases before they could reach the electrodes.

In another embodiment, an electrochemical sensor system can be provided, which includes a filter comprising a micro-porous solid possessing a large surface area, wherein the filter is located within a container sealed with a cap. A heater and hydrogen-generating chamber can also be disposed proximate to the charcoal filter within the container. Additionally, a water-gel layer comprising water trapped within a polymer matrix can be provided, wherein the water-gel layer is located below the heater and hydrogen-generating chamber within the container in order to slow down water evaporation and wherein the water-gel includes an antiseptic solution. One or more hydrophobic layers are also disposed between the filter and the water-gel.

Additionally, a gas diffusion control layer can be disposed between the heater and hydrogen generating chamber and at least one hydrophobic layer, wherein a plurality of holes are formed from the gas diffusion control layer, which link the heater and hydrogen generating chamber to the at least on hydrophobic layer. Finally, one or more electrolyte and catalyst electrodes can be disposed between a first hydrophobic layer and a second hydrophobic layer of the at least one hydrophobic layer, thereby providing extended electrochemical sensing capabilities for the electrochemical sensor system. The container itself can comprise nickel-plated steel. The cap can also be configured from nickel-plated steel.

In accordance with a third embodiment, an electrochemical sensor system can be provided, which includes an array of electrochemical sensors associated with a sensor package, wherein each sensor among the array of sensors is classified according to its response to a set of analytes and wherein each sensor is configured from a different catalyst and/or coating. Additionally, each catalyst and/or coating selected responds different to one or more members among a group of analytes thereby producing a unique signature for each analyte thereof and providing multiple electrochemical sensing capabilities thereof. An electrode(s) is also associated with each sensor of the array.

The set of analytes and the electrode(s) can be selected from a list of materials respectively including, but not limited to, one or more of the following types of analytes and electrode materials: Carbon monoxide: Platinum, Ruthenium; Hydrogen Sulphide: Platinum, Gold; Oxygen: Platinum, Gold, Silver, Rhodium; Hydrogen: Palladium, Platinum, Gold; Sulphur Dioxide: Gold; and Carbon Dioxide: Platinum, Silver. The array of electrochemical sensors associated with the sensor package can include, for example, one, two, three, four or more sensors, depending upon design considerations.

### BRIEF DESCRIPTION OF THE DRAWINGS

The accompanying figures, in which like reference numerals refer to identical or functionally-similar elements throughout the separate views and which are incorporated in and form a part of the specification, further illustrate embodiments and, together with the detailed description of the invention, serve to explain the principles of the embodiments disclosed herein.

FIG. 1 illustrates a sensor system, which can be implemented in accordance with one embodiment;

FIG. 2 illustrates a sensor system, which can be implemented in accordance with an alternative embodiment;

FIG. 3 illustrates a sensor system, which can be implemented in accordance with another embodiment; and

FIG. 4 illustrates a sensor system, which can be implemented in accordance with an additional embodiment.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

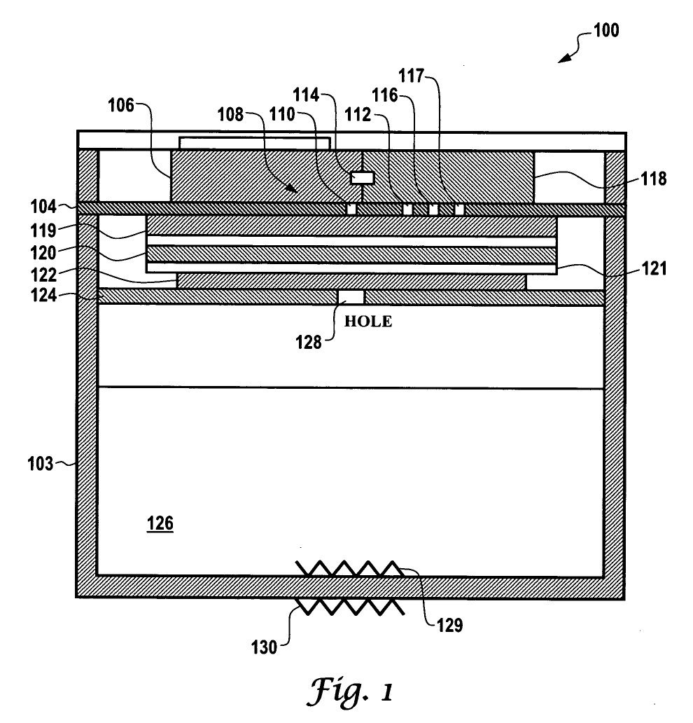

FIG. 1 illustrates a sensor system 100, which can be implemented in accordance with one embodiment. System 100 can be implemented as an electrochemical sensor with an extended life and wide working temperature range. System 100 can include a nickel-plated steel housing 103 (e.g., a can) that encases an active charcoal filter 106 located adjacent a heater and H₂ generating chamber 118. In such a hydrogen generating chamber 118, the heater can heat up the metal hydrides to release hydrogen. The generated hydrogen can be used for self-testing or self-calibrating of the sensors. A pressure-releasing hole 114 can be located between or integrated with the active charcoal filter 106 and chamber 118.

One or more diffusion holes 110, 112 can be provided respectively adjacent charcoal filter 106 and chamber 118. One or more larger holes 116, 117 can also be located near chamber 118. A gas diffusion control layer 104 can be configured below charcoal filter 106 and chamber 118 and may be configured from a material, such as, for example, stainless steel. Holes 110, 112, 116, and 117 can be configured from the diffusion control layer 104.

A hydrophobic layer 119 configured from example, Teflon, can be located below the diffusion control layer 104 and above a layer 120 comprising electrolyte (e.g., Nafion) and one or more catalyst electrodes. A layer 121 can be located between layer 120 and a layer 122 composed of hydrophobic Teflon. A washer 124 can be located below layer 122. A hole 128 can be configured from washer 124, which in turn is located above a layer 126 that can be composed of water or water/gel with an antiseptic solution. Heaters 129 and 130 can be located either inside or outside of the sensor.

System 100 addresses the fact that freezing of an electrolyte/water reservoir and boiling of such an electrolyte/water reservoir limits the working temperature of electrochemical sensors. As the temperature of the cell decreases, the chemical reaction, which the user “sees” as a signal decreases. At some point, depending upon the electrolyte, the cell current stops. Usually, upon returning to a normal temperature, the cell reactivates. If an electrochemical sensor is to be utilized in temperatures below its normal operating temperature range, the cell should be heated. In general, the lowest temperature at which a cell can be expected to function properly over long periods of time is 0° C.

In the configuration of system 100, the heaters 129 or 130 can be utilized when electrochemical cells associated with system 100 are applied in temperatures below its normal operating temperatures. Water-gels, such as those located in layer 126 can be utilized to slow down waver evaporation to extend the life of sensor system 100. Water-gels can be regarded as water trapped in a polymeric matrix. Evaporation of water is slowed by the polymer matrix and can be further slowed by the incorporation of hygroscopic materials facilitating ion movement within the gel.

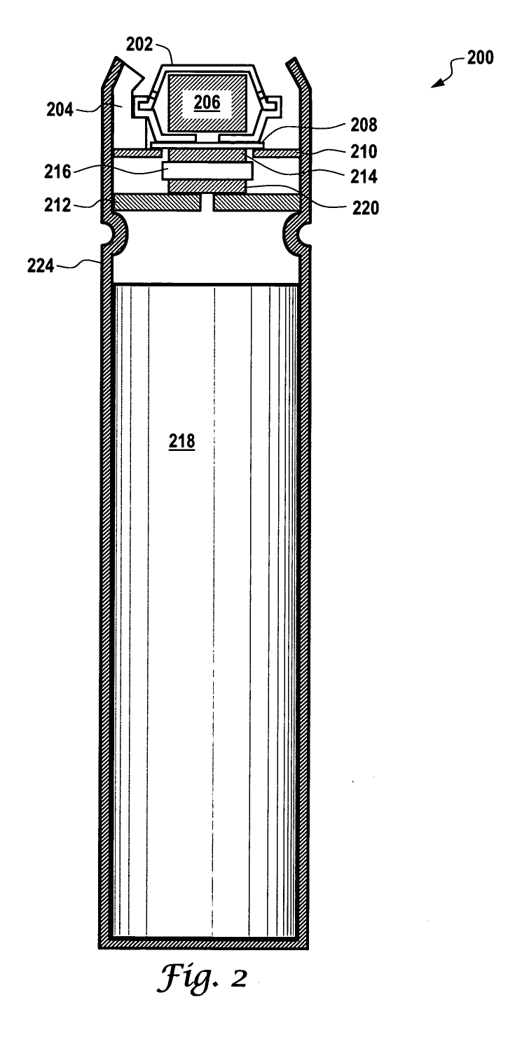

FIG. 2 illustrates a sensor system 200, which can be implemented in accordance with an alternative embodiment. System 200 includes a cap 202, which can be configured as a nickel-plated cap and located above a can 224 that can also be formed from nickel-plated steel, similar to the nickel-plated steel housing 103 depicted in FIG. 1. Additionally, system 200 includes a gasket 204, which can be formed from a material such as 66-nylon. An active charcoal filter 206 is contained within cap 202. Note that the active charcoal filter 206 of FIG. 2 is similar to the active charcoal filter 106 depicted in FIG. 1. Note that although actives charcoal filters 106 and 206 are depicted respectively in FIGS. 1-2, such filters can be

A gas diffusion control stainless film 208 can be disposed below cap 202 above a hydrophobic Teflon membrane 214, 220, while surrounding a proton exchange membrane 216 (i.e. with a catalyst). A layer 218 can also be provided, which can be, for example, water or water-gel (with an antiseptic solution).

System 200 can be implemented in accordance with common materials for physical sorption, such as activated charcoal, silica, alumina gels, zeolites, porous polymers (e.g., Tenax, XAD, Chromosorb). Adsorbents tend to be micro-porous solids processing large surface areas (e.g., 200 to 1000 m2g). A high degree of discrimination can be achieved by the use of size-specific materials, having a controlled pore size slightly larger than the kinetic diameter of the desired analyte. Such a configuration excludes all larger species form the pores entirely. Molecules significantly smaller than the chosen analyte though are able to fit into the pores, and possess smaller interaction energy due to the size mismatch.

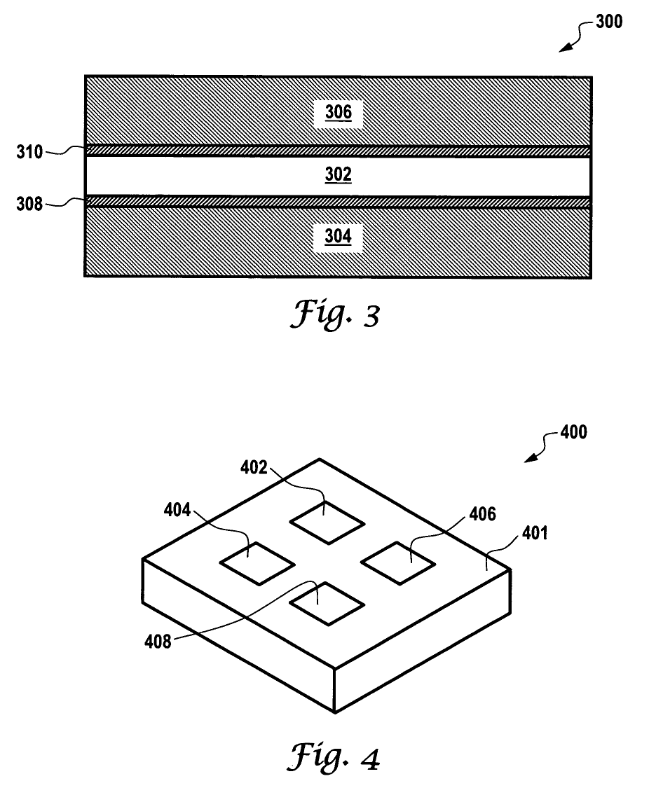

FIG. 3 illustrates a sensor system 300, which can be implemented in accordance with another embodiment. System 300 includes two electrodes 308, 310 that border an electrolyte (e.g., Nafion) membrane 302. Note the electrolyte membrane 302 and electrodes 308, 310 form a layer, which is analogous to layer 120 of FIG. 1. Thus, electrodes 308, 310 can function as catalyst electrodes. A polymer selective permeable filter (e.g., Gore-Tex or carbel coating) 306 can be positioned adjacent electrode 310. Similarly, a polymer selective permeable filter (e.g., Gore-Tex or carbel coating 304) can be located adjacent electrode 308.

A suggested width of the filter 306 layer can be, for example, 0.3 mm, while a suggested width of the electrode 308, 310 can be, for example, 0.05 mm. A suggested width of the membrane 302 can be, for example, 0.06 mm. Note that such widths are suggestions only and it can be appreciated that such values can vary, depending upon particular embodiments and design considerations.

FIG. 4 illustrates a sensor system 400, which can be implemented in accordance with an additional embodiment. System 400 can be implemented as a sensor package in which a heater, such as, for example, the heater 130 depicted in FIG. 1, can be located within this multiple-sensor system 400. System 400 can thus be utilized to implement systems 100-300 depicted and described herein. System 400 additionally includes a plurality of electrochemical sensors 402, 404, 406, 408, which can be implemented, for example, in accordance with the embodiments of sensors 100, 200, 300 of FIGS. 1, 2, 3.

Thus, for example, system 400 can include individual sensors 402, 404, 406, 408, each of which is embodied as, for example, system 100, including the nickel-plated steel housing 103 (e.g., a can) that encases an active charcoal filter 106 located adjacent a heater and H₂ generating chamber 118, the pressure-releasing hole 114 located between or integrated with the active charcoal filter 106 and chamber 118, one or more diffusion holes 110, 118 and so forth.

System 400 is directed toward the fact that hydrogen sensors are utilized for fuel cell and transformer monitoring, but cross-sensitivity among H2, CO, CH4, C2H2 and the like can cause false alarms. Thus, the sensors 402, 404, 406, 408 are arranged as an array configuration. The selectivity of sensor system 400 takes advantage of chemo-metrics. A minimum number of sensors for system 400 can be utilized. Sensors exhibiting similar responses are preferably eliminated.

A selection of one or more of sensors 402, 404, 406, 408 is preferably based on its sensitivity, selectivity, stability and/or cost. Improvements are achieved by utilizing selective permeable filters. Interferences, however, may not always be known prior to the use of sensors. Thus, applications that require the simultaneous monitoring for multiple analytes require multiple sensors. In such cases, an array of sensors 402, 404, 406, 408, each bearing a catalyst/coating with a different degree of selectivity for the analytes of interest, can be implemented.

In terms of pattern-recognition analysis, a sensor can be classified according to its response to a set of analytes. Each sensor 402, 404, 406, 408 of the array of sensors depicted in FIG. 4 can be designed with a different catalyst/coating, wherein each catalyst/coating is selected to respond differently to the members of a set of analytes. The combination of responses thereof should produce a unique “fingerprint” for each analyte.

In general, system 400 includes an array of electrochemical sensors 402, 404, 406, 408 associated with a sensor package 401, wherein each sensor 402, 404, 406, 408 of the array is classified according to its response to a set of analytes. Additionally, each sensor is configured from a different catalyst and/or coating. Note that each catalyst and/or coating selected responds differently to one or more members among a group of analytes thereby producing a unique signature for each analyte thereof and providing multiple electrochemical sensing capabilities for sensor system 400.

The efficiency of the array of sensors 402, 404, 406, 408 depends on the uniqueness of the catalyst/coating responses thereof. A suggested list of analyte/electrode materials, which can be utilized in accordance with system 400, include, for example, the following:
Carbon monoxide: Platinum, Ruthenium
Hydrogen Sulphide: Platinum, Gold
Oxygen: Platinum, Gold, Silver, Rhodium
Hydrogen: Palladium, Platinum, Gold
Sulphur Dioxide: Gold
Carbon Dioxide: Platinum, Silver

Although four sensors 402, 404, 406, 408 are illustrated in FIG. 4, it can be appreciate that an embodiment be implemented in an array configuration in which only two such sensors are utilized. Thus, in one embodiment of FIG. 4, a two sensor array can be implemented, wherein one sensor is more sensitive to H₂, but less to CO, while the other sensor is more sensitive to CO, and less to H₂. In such an embodiment, the first sensors can be implemented as a Pt electrode Nafion-based sensor, while the second sensor can be implemented as a Pd electrode Nafion-based sensor. Both such sensors can be equipped with self-test calibration features. Because the first and second sensors possess cross-sensitivity with H₂ and CO, the response from both sensors will be used to determine the concentration of H₂ and CO.

In such an embodiment, the Pt electrode can possess an H₂ equivalent of 25% CO, and the Pd electrode can possess an H₂ equivalent of 150% CO. Thus, if the reading from the first sensor to the second sensor is A and B, respectively, the H₂ and CO concentrations can be determined according to the following formulation (assuming H₂ and CO concentrations are X and Y ppm):
From Pt electrode: 0.25X+Y=A
From Pd electrode: X+0.67Y=B

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

What is claimed is:

1. An electrochemical sensor system, comprising:
a filter comprising a micro-porous solid possessing a large surface area, wherein said filter is located within a container sealed with a cap a heater and hydrogen generating chamber disposed proximate to said charcoal filter within said container; and
a layer comprising water trapped within a polymer matrix, wherein said layer is located below said heater and hydrogen generating chamber within said container in order to slow down water evaporation and provided extended electrochemical sensing capabilities for said electrochemical sensor system.

2. The system of claim 1, further comprising:
a water reservoir containing water or a water-based solution, wherein said water reservoir is located within said container sealed with said cap; and
a heater disposed proximate to said water reservoir, wherein said heater is utilized to heat said water reservoir.

3. The system of claim 2 wherein said water trapped within said polymer matrix comprises a water-gel.

4. The system of claim 3 further comprising at least one hydrophobic layer disposed between said filter and said water-gel.

5. The system of claim 3 wherein said water-gel includes an antiseptic solution.

6. The system of claim 3 further comprising:
a gas diffusion control layer disposed between said heater and hydrogen generating chamber and said at least one hydrophobic layer, wherein a plurality of holes are formed from said gas diffusion control layer, which link said heater and hydrogen generating chamber to said at least on hydrophobic layer.

7. The system of claim 6 further comprising one or more electrolytes and catalyst electrodes disposed between a first hydrophobic layer and a second hydrophobic layer of said at least one hydrophobic layer.

8. The system of claim 2 wherein said container comprises nickel-plated steel and said cap comprises nickel-plated steel.

9. The system of claim 2 wherein said large area of said micro-porous solid posses an area in a range of approximately 200 m2/g to 1000 m₂/g.

10. An electrochemical sensor system, comprising:
a filter comprising a micro-porous solid possessing a large surface area, wherein said filter is located within a container sealed with a cap
a water reservoir containing water or a water-based solution, wherein said water reservoir is located within said container sealed with said cap
a heater disposed proximate to said water reservoir, wherein said heater is utilized to heat said water reservoir
a heater and hydrogen generating chamber disposed proximate to said charcoal filter within said container;
a water-gel layer comprising water trapped within a polymer matrix, wherein said water-gel layer is located below said heater and hydrogen generating chamber within said container in order to slow down water evaporation and wherein said water-gel includes an antiseptic solution;
at least one hydrophobic layer disposed between said filter and said water-gel;
a gas diffusion control layer disposed between said heater and hydrogen generating chamber and said at least one hydrophobic layer, wherein a plurality of holes are formed from said gas diffusion control layer, which link said heater and hydrogen generating chamber to said at least on hydrophobic layer; and
wherein one or more electrolytes and catalyst electrodes disposed between a first hydrophobic layer and a second hydrophobic layer of said at least one hydrophobic layer, thereby providing extended electrochemical sensing capabilities for said electrochemical sensor system.

11. The system of claim 10 wherein said container comprises nickel-plated steel and said cap comprises nickel-plated steel.

12. The system of claim 10 wherein said large area of said micro-porous solid posses an area in a range of approximately 200 m²/g to 1000 m₂/g.

13. The system of claim 10 wherein said large area of said micro-porous solid contains alkaline materials

14. An electrochemical sensor system, comprising:
an array of electrochemical sensors associated with a sensor package, wherein each sensor among said array of sensors is classified according to its response to a set of analytes and wherein each sensor is configured from a different catalyst and/or coating; and
wherein each catalyst and/or coating selected responds different to one or more members among a group of analytes thereby producing a unique signature for each analyte thereof and providing multiple electrochemical sensing capabilities thereof.

15. The system of claim 14 further comprising an electrode associated with each sensor of said array.

16. The system of claim 15 wherein said set of analytes and said electrode are selected from a list of materials respectively comprising at least one of the following types of analyte and electrode materials: Carbon monoxide: Platinum, Ruthenium; Hydrogen Sulphide: Platinum, Gold; Oxygen: Platinum, Gold, Silver, Rhodium; Hydrogen: Palladium, Platinum, Gold; Sulpher Dioxide: Gold; and Carbon Dioxide: Platinum, Silver.

17. The system of claim 15 wherein said an array of electrochemical sensors associated with said sensor package comprises four sensors.

18. The system of claim 15 wherein said an array of electrochemical sensors associated with said sensor package comprises two sensors, including a first sensor and a second sensor.

19. The system of claim 18 wherein said first sensor is more sensitive to H₂ and less sensitive to CO and said second sensor is more sensitive to CO and less sensitive to CO.

20. The system of claim 19 wherein said first sensor is associated with a Pt electrode and said second sensor is associated with a Pd electrode.

21. The system of claim 20 wherein said first sensor and said second sensor each possess a cross-sensitivity with H₂ and CO, thereby contributing a response from said first and second sensors that determines a concentration of H₂ and CO.

22. The system of claim 15 wherein each sensor of said array comprises self-test and self-calibration features.
